(19) United States
(12) Patent Application Publication
(10) Pub. No.: US 2010/0231355 A1
(43) Pub. Date: Sep. 16, 2010

(54) INFORMATION PROCESSING APPARATUS

(75) Inventors: Yumiko Okuma, Tokyo (JP); Maki Sato, Kanagawa (JP); Takashi Makiyama, Tokyo (JP); Masanori Sambe, Shizuoka (JP); Hisashi Sato, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/712,425

(22) Filed: Feb. 25, 2010

(30) Foreign Application Priority Data
Mar. 11, 2009 (JP) 2009-058495

(51) Int. Cl. G06F 7/04

(52) U.S. Cl. 340/5.8

(57) ABSTRACT

An information processing apparatus includes: an authenticating unit configured to perform, when an input from an operator not having operation authority is received on a restricted input button that can be operated only by an operator having the operation authority, authentication by the operator having the operation authority; and a restriction releasing unit configured to temporarily release the operation restriction for the restricted input button when the authentication by the operator having the operation authority is successful.

### CROSS-REFERENCE TO RELATED APPLICATION

This application claims the benefit of priority from Japanese Patent Application No. 2009-058495 filed on Mar. 11, 2009, the entire content of which is incorporated herein by reference.

### TECHNICAL FIELD

The present invention relates to an information processing apparatus configured to release operation restriction applied to processing.

### BACKGROUND

Conventionally, in a store that sells commodities, a checkout processing apparatus configured to perform, for example, checkout processing for commodities ordered by a customer is set as an information processing apparatus. In such an apparatus, it is desired to limit people allowed to perform operation of unusual processing not usually performed (hereinafter referred to as restricted processing) such as cancellation processing for canceling an order of a commodity already received or substantial discount processing to only people having operation authority decided in advance such as a store manager to thereby prevent illegal acts by other operators.

Therefore, an electronic cash register as an example of the checkout processing apparatus requires, during the start of operation or during a shift of operation, a person in charge of operation to input a code uniquely allocated to the person and identifies an operator with the code. In performing the restricted processing, the electronic cash register determines whether an operator currently operating the electronic cash register is a person having the operation authority decided in advance. If the person having the operation authority is currently performing the operation, the electronic cash register directly executes the restricted processing. On the other hand, if the operator currently operating the electronic cash register does not have the operation authority, the electronic cash register processes the operation as an operation error.

However, when a situation in which the restricted processing has to be executed arises while an operator not having the operation authority is operating the electronic cash register, the operator has to log out after once stopping the processing and ask the operator having the operation authority to log in. It takes time to ask the operator having the operation authority to log in and execute the restricted processing. Further, after the restricted processing is executed, the operator not having the operation authority has to ask the operator having the operation authority to log out and has to log in again. Such a loss of time has to be reduced in an apparatus used at a counter where quick customer handling is required.

Therefore, an electronic cash register disclosed in JP-A-9-44749 requests, when an operator currently operating the electronic cash register is a person not having operation authority, the operator to input a code necessary for executing the restricted processing and releases, when the input code coincides with a code set and stored in advance, the operation restriction for the restricted processing.

However, when the operation restriction for the restricted processing is released on condition that the input code coincides with the code set and stored in advance as explained above, it is impossible to determine whether the input code is personally input by the operator having the operation authority or is input by the operator not having the operation authority. Therefore, strict confidentiality management and frequent setting change for the code are required. This is because, if the operation of the confidentiality management and the setting change is neglected, meaning for providing the operation restriction is lost, a security level falls, and anybody can perform the operation of the restricted processing, leading to illegal acts by malicious operators.

### SUMMARY

It is an object of the present invention to quickly perform, when an operator is changed from the operator not having the operation authority to the operator having the operation authority, authentication of the operator and authority of the operator.

According to an aspect of the present invention, there is provided an information processing apparatus including: an authenticating unit configured to perform, when an input from an operator not having operation authority is received on a restricted input button that can be operated only by an operator having the operation authority, authentication by the operator having the operation authority as operation restriction for the restricted input button; and a restriction releasing unit configured to temporarily release the operation restriction for the restricted input button when the authentication by the operator having the operation authority is successful.

According to another aspect of the present invention, there is provided an information processing apparatus including: a display unit in a device configured to input and output information; an authenticating unit configured to perform, when an input from an operator not having operation authority is received on a restricted input button that is displayed on the display unit and can be operated only by an operator having the operation authority, authentication by the operator having the operation authority as operation restriction for the restricted input button; and a restriction releasing unit configured to temporarily release the operation restriction for the restricted input button when the authentication by the operator having the operation authority is successful.

According to still another aspect of the present invention, there is provided an information processing method including: performing, when an input from an operator not having operation authority is received on a restricted input button that can be operated only by an operator having the operation authority, authentication by the operator having the operation authority as operation restriction for the restricted input button; and temporarily releasing the operation restriction for the restricted input button when the authentication by the operator having the operation authority is successful.

According to the present invention, when an operator is changed from the operator not having the operation authority to the operator having the operation authority, authentication of the operator and authority of the operator can be quickly performed. Therefore, it is possible to quickly deal with customers and realize improvement of services.

### DESCRIPTION OF THE DRAWINGS

FIG. 1 is a block diagram of electric connection of an information terminal;

FIG. 2 is a schematic diagram of an example of a file structure of an authority file;

FIG. 3 is a block diagram of the configuration of the information terminal;

FIG. 4 is a schematic diagram of an example of an operation screen;

FIG. 5 is a schematic diagram of an example of an authentication screen; and

FIG. 6 is a flowchart for explaining a flow of restriction release processing by the information terminal.

### DETAILED DESCRIPTION

Exemplary embodiments of the present invention are explained in detail below with reference to the accompanying drawings.

An embodiment of the present invention is an example in which a checkout apparatus configured to perform checkout work for an order received from a customer is an information processing apparatus. An information terminal as the information processing apparatus according to this embodiment can receive an input of order information concerning a menu order and prints and issues a slip including content corresponding to the order information. The printed and issued slip is a cooking instruction slip for instructing chefs in a kitchen about ordered menu items. The information terminal also functions as a point of sales (POS) terminal and executes checkout processing.

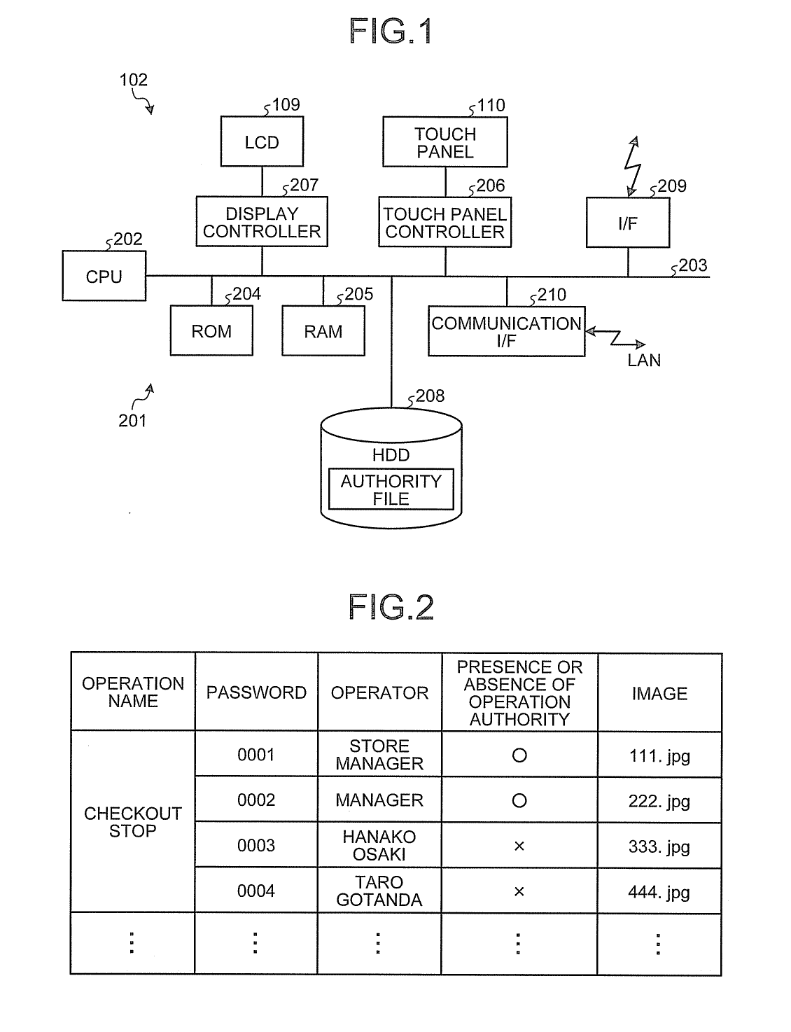

FIG. 1 is a block diagram of electric connection of the information terminal according to this embodiment. As shown in FIG. 1, an information terminal 102 (a checkout apparatus) includes a microcomputer 201. The microcomputer 201 drives to control units of the information terminal 102. In the microcomputer 201, a read only memory (ROM) 204 having stored therein in advance fixed information such as a control program and a random access memory (RAM) 205 configured to rewritably store various kinds of information and function as a work area and the like are connected via a bus line 203 to a central processing unit (CPU) 202 configured to centrally control the units. Therefore, the microcomputer 201 configures an information processing unit configured to execute information processing.

A touch panel controller 206, a display controller 207, a hard disk drive (HDD) 208, an interface (I/F) 209, and a communication interface 210 are connected to the microcomputer 201 via the bus line 203.

The touch panel controller 206 captures an input signal from the touch panel 110 into the microcomputer 201. The display controller 207 drives to control a liquid crystal display 109 on the basis of image data and causes the liquid crystal display 109 to display an image corresponding to the image data. The interface 209 is an interface for connecting a keyboard, a mouse, a printer, and a customer-side display device to the microcomputer 201. The interface 209 includes a USB. The communication interface 210 is an interface for enabling the microcomputer 201 to perform data communication with other apparatuses through a local area network (LAN).

The HDD 208 has stored therein an operating system (OS), a computer application program (an application), various files, and the like. All or a part of the OS, the application, the various files, and the like are copied to the RAM 205 and accessed by the CPU 202 during the start of the information terminal 102. The CPU 202 executes processing conforming to the OS and the application copied in this way.

The HDD 208 has stored therein, for each of operations, an authority file in which operators and presence or absence of operation authority for the operation for restricted processing are associated. FIG. 2 is a schematic diagram of an example of a file structure of the authority file. As shown in FIG. 2, in the authority file, a password, an operator, presence or absence of operation authority, and an image are registered in association with each other for one operation. In the authority file shown in FIG. 2, as an example, information for operation “stop checkout” is registered. For example, it is seen that a store manager has a password “0001” and has operation authority for stopping checkout and Ms. Hanako Osaki has a password “0003” and does not have the operation authority for stopping checkout. It is assumed that the HDD 208 has stored therein authority files not only for the operation for stopping checkout but also for other operations for restricted processing.

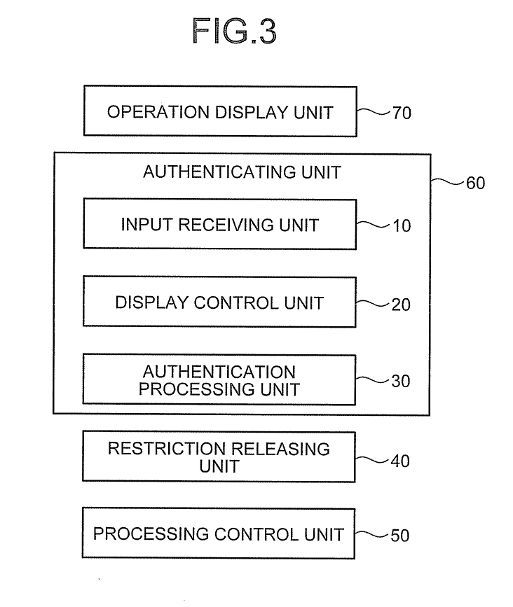

Characteristic processing of the information terminal 102 according to this embodiment among kinds of processing executed by the microcomputer 201 according to the OS and the application installed in the HDD 208 of the information terminal 102 is explained below. FIG. 3 is a block diagram of the configuration of the information terminal according to this embodiment.

The application executed by the information terminal 102 according to this embodiment has a module configuration including an operation display unit 70, an authenticating unit 60 (including an input receiving unit 10, a display control unit 20, and an authentication processing unit 30), a restriction releasing unit 40, and a processing control unit 50. These modules are appropriately read from the HDD 208 by the CPU 202 of the microcomputer 201, loaded onto the RAM 205, and executed to cause the information terminal 102 to realize functions of the operation display unit 70, the authenticating unit 60 (including the input receiving unit 10, the display control unit 20, and the authentication processing unit 30), the restriction releasing unit 40, and the processing control unit 50.

The information terminal 102 according to this embodiment displays, on a restricted input button that an operator who already logs in cannot operate in an operation screen D of the operator, an icon informing the operator that the operator cannot operate the restricted input button. If the operator inputs a password to an authentication screen E displayed when the operator touches the restricted input button, the operator can temporarily release operation restriction and operate restricted processing.

The operation display unit 70 displays, on the liquid crystal display 109, a login screen on which an operator who operates the information terminal 102 logs in. The operation display unit 70 receives login from the operator. When the login from the operator is received, the operation display unit 70 displays, on the liquid crystal display 109, the operation screen D in which input buttons indicating operations that can be performed by any operator and a restricted input button.

The restricted input button is an input button for receiving restricted processing that can be operated only by an operator having operation authority. The restricted input button can receive operation from, for example, the operation screen D displayed when the operator having the operation authority logs in. The input buttons other than the restricted input button are input buttons that can be operated by any operator. In the operation screen D, the restricted input button is provided in a form that can be visually distinguished from the input buttons that can be operated by any operator. The operation display unit 70 receives inputs of various input buttons including the restricted input button from the operation screen D.

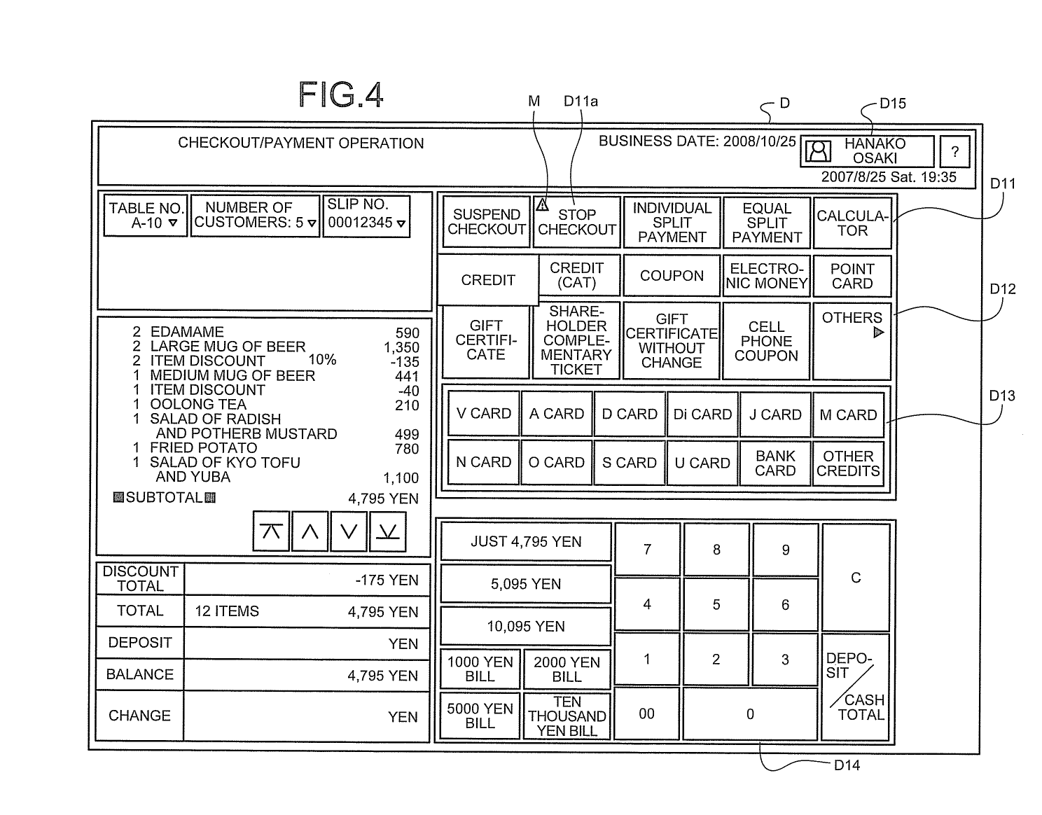

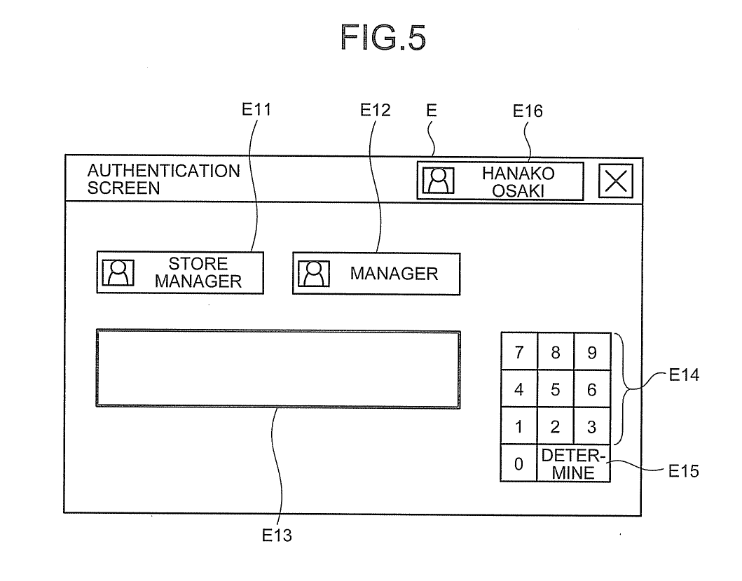

FIG. 4 is a schematic diagram of an example of the operation screen D. As shown in FIG. 4, checkout related operation D11, a checkout method D12, a card type D13, a ten key D14, a login operator D15, and the like are displayed on the operation screen D.

In the checkout related operation D11, a “suspend checkout” button for once suspending checkout, a “stop checkout” button 11a for stopping checkout, an “individual split payment” button for individually splitting the bill for plural customers, an “equal split payment” button for equally splitting the bill for plural customers, and a “calculator” button for switching to a calculator screen are displayed as objects that can be touch-designated through the touch panel 110.

In the “stop checkout” button D11a, a mark M with the exclamation mark shown in a triangle is displayed. The mark M indicates that an input button on which the mark N is displayed is a restricted input button that an operator who currently logs in cannot operate and only an operator having operation authority can operate. It can be recognized that Ms. Hanako Osaki who currently logs in does not have operation authority for stopping checkout.

In the checkout method D12, a button indicating a method of checkout is displayed. Specifically, for example, a “credit” button indicating that credit checkout is performed and an “electronic money” button indicating that checkout is performed with electronic money are displayed as objects that can be touch-designated through the touch panel 110.

In the card type D13, a button indicating a type of a card used when a customer makes payment by card is displayed as an object that can be touch-operated through the touch panel 110.

The ten key D14 is a key for inputting the price received from a customer to perform checkout. 0 to 9 buttons and the like are displayed as objects that can be touch-designated through the touch panel 110.

In the login operator D15, a name and an image of an operator who currently logs in are displayed. In FIG. 4, it is seen that the operation screen D is an operation screen (a checkout and payment operation screen) displayed in a state in which Ms. Hanako Osaki logs in.

The authenticating unit 60 is a unit configured to perform authentication by the operator having the operation authority. The authenticating unit 60 includes the input receiving unit 10, the display control unit 20, and the authentication processing unit 30.

The input receiving unit 10 receives the input of a password (operator identification information) peculiar to an operator from an authentication screen (see FIG. 5) displayed by the display control unit 20.

When the input of the restricted input button is received from an operator not having the operation authority on the operation screen displayed by the operation display unit 70, the display control unit 20 displays an authentication screen for authenticating whether the operator is the operator having the operation authority.

For example, on the operation screen shown in FIG. 4, the display control unit 20 displays the authentication screen when the input of the checkout stop button attached with the mark M is received from Ms. Hanako Osaki not having the operation authority for stopping checkout. On the authentication screen, operator information indicating the operator having the operation authority for the operation indicated by the restricted input button is displayed.

FIG. 5 is a schematic diagram of an example of the authentication screen. On the authentication screen E, operator information buttons E11 and E12 are displayed. On the operator information buttons E11 and E12, names of operators having the operation authority for the operation indicated by the restricted input button, the input of which is received, and images for enabling visual recognition of the operators having the operation authority such as face photographs or portraits of the operators are shown as operator information. Specifically, FIG. 5 indicates that the store manager and a manager are the operators having the operation authority. A password input field E13 is displayed on the authentication screen E. The operator having the operation authority for the operation indicated by the restricted input button, the input of which is received, touches the operation information button of the operator and then inputs a password from a ten key 514 and determines the password with a determination key E15. Then, authentication by the authentication processing unit 30 is performed. If the authentication is successful, the restriction of operation is temporarily released. Login operator information E16 in which a name and an image of the operator who currently logs in are displayed is displayed at the upper right of the authentication screen E. FIG. 5 indicates that Ms. Hanako Osaki logs in.

When the password is input by the operator having the operation authority from the authentication screen, the authentication processing unit 30 refers to the authority file stored in the HDD 208 and authenticates whether the operator who inputs the password is the operator having the operation authority for the operation indicated by the restricted input button, the input of which is received.

For example, when FIGS. 2, 4, and 5 are refereed to, Ms. Hanako Osaki inputs the checkout stop button, for which she does not have operation authority, from the operation screen (FIG. 4) and the authentication screen E (FIG. 5) is displayed as a popup screen over the operation screen D. The store manager having the operation authority touches the operator information button E11 of the store manger and inputs the password “0001” to the field E13. When the input password “0001” and the operation name “checkout stop” of the authority file (FIG. 2) are referred to, since the password of the store manager is “0001”, it is recognized that the store manager is identified. The authentication is successful because the store manager has the operation authority.

If the authentication by the authentication processing unit 30 is successful, the restriction releasing unit 40 temporarily releases the restriction of the operation indicated by the restricted input button, the input of which is received. When the processing for the operation for which the restriction is temporarily released ends, the restriction releasing unit 40 applies restriction of operation to the restricted input button again.

The processing control unit 50 performs the restricted processing when the restriction of the operation for the restricted processing indicated by the restricted input button, the input of which is received, is temporarily released by the restriction releasing unit 40 because the authentication by the authentication processing unit 30 is successful.

When the operator having the operation authority inputs the password from the authentication screen and the restriction of the operation is temporarily released in this way, the operator having the operation authority can perform the operation indicated by the restricted input button, the input of which is received. When the processing for the operation for which the restriction is temporarily released ends, the operation display unit 70 displays, on the liquid crystal display 109, the original operation screen, i.e., the operation screen before the restriction of the operation is temporarily released.

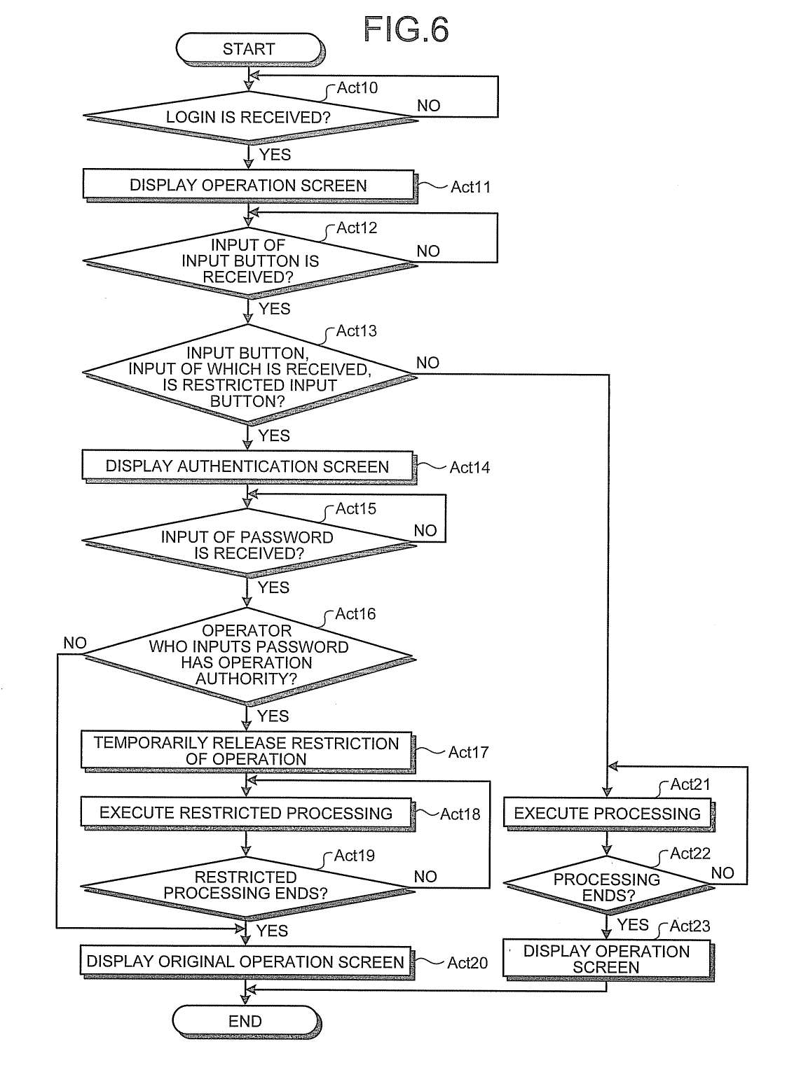

Restriction release processing by the information terminal 102 configured as explained above is explained below. FIG. 6 is a flowchart for explaining a flow of restriction release processing by the information terminal according to this embodiment.

First, the operation display unit 70 determines whether login by an operator is received from the login screen (Act 10). If login is not received (No in Act 10), the operation display unit 70 stays on standby until login is received. On the other hand, if login is received (Yes in Act 10), the operation display unit 70 displays the operation screen on the liquid crystal display 109 (Act 11). The operation display unit 70 determines whether the input of an input button by the logged-in operator is received (Act 12). If the input is not received (No in Act 12), the operation display unit 70 stays on standby until the input is received. On the other hand, if the input of the input button is received (Yes in Act 12), the operation display unit 70 determines whether the input button, the input of which is received, is the restricted input button (Act 13). If it is determined that the input button is the restricted input button (Yes in Act 13), the display control unit 20 displays the authentication screen E (Act 14).

The input receiving unit 10 determines whether the input of a password is received from the authentication screen E (Act 15). If the input of a password is not received (No in Act 15), the input receiving unit 10 stays on standby until the input of a password is received. On the other hand, if the input of a password is received (Yes in Act 15), The authentication processing unit 30 determines whether an operator who inputs the password is the operator having the operation authority for the operation indicated by the restricted input button, the input of which is received (Act 16). If the operator is not the operator having the operation authority (No in Act 16), the processing proceeds to processing in Act 20.

On the other hand, if the operator is the operator having the operation authority (Yes in Act 16), the restriction releasing unit 40 temporarily releases the restriction of the operation for the restricted processing indicated by the restricted input button, the input of which is received (Act 17). The processing control unit 50 executes, according to the input of the operator having the operation authority, restricted processing indicated by the restricted input button, the input of which is received (Act 18).

The operation display unit 70 determines whether the restricted processing by the processing control unit 50 ends (Act 19). If the restricted processing does not end (No in Act 19), the processing returns to Act 18 and the restricted processing is continued. On the other hand, if the restricted processing ends (Yes in Act 19), the restriction releasing unit 40 applies the restriction of the operation to the restricted input button again. The operation display unit 70 displays the original operation screen, i.e., the operation screen D before the restriction of the operation is temporarily released (Act 20).

If it is determined in Act 13 that the input button, the input of which is received, is not the restricted input button (No in Act 13), the processing control unit 50 executes, according to the input of the operator, processing for the operation indicated by the input button, the input of which is received (Act 21). The operation display unit 70 determines whether the processing by the processing control unit 50 ends (Act 22). If the processing does not end (No in Act 22), the processing returns to Act 21. On the other hand, if the processing ends (Yes in Act 22), the operation display unit 70 displays the operation screen D (Act 23).

In this way, in the information terminal 102 according to this embodiment when the operator touches, in the operation screen D to which the operator logs in, the restricted input button for which the operator does not have the operation authority, the authentication screen E is displayed. When the operator having the operation authority inputs a password to the authentication screen E, the operator not having the operation authority can temporarily release the restriction of operation and perform the restricted processing.

After the processing for the operation for which the restriction is temporarily released ends, the original operation screen D is displayed.

Therefore, for example, when a customer requests cancellation of an ordered menu item, the operator not having the operation authority for the restricted processing can temporarily release the operation restriction on the operation screen to which the operator logs in. Therefore, while maintaining security for allowing only a person having the operation authority to perform operation, when an operator is changed from the operator not having the operation authority to the operator having the operation authority, it is possible to quickly perform authentication of the operator and authority of the operator. Therefore, it is possible to quickly deal with customers and realize improvement of services.

In the information terminal 102 according to this embodiment, on the operation screen of the operator who already logs in, the restricted input button that cannot be operated by the operator is displayed in a form that can be visually distinguished from the input button that can be operated by the operator. Specifically, for example, an icon informing inoperability is shown on the restricted input button. Consequently, it is possible to cause the operator to recognize that the restricted input button is a button to which the operation authority is given and the operator needs to input a password to log in. The restricted input button is a function button unnecessary for a person not having the operation authority. However, for example, cancellation processing for canceling an ordered menu item is often performed when a store clerk makes a mistake in ordering. Therefore, all store clerks are required to quickly cope with a complaint of a customer at a point when the customer makes the complaint irrespectively of whether the store clerks have the operation authority. Therefore, the restricted input button is displayed even on the operation screen of the operator not having the operation authority and the authentication screen E, on which the operator having the operation authority is displayed, is displayed. Consequently, the operator not having the operation authority can quickly request the operator having the operation authority to perform processing.

On the authentication screen E displayed when the restricted input button is touched, information (a name, an image, etc.) of the operator having the authority for the operation indicated by the restricted input button is displayed. Therefore, even a store clerk having little job experience in the store can intuitively recognize who has the operation authority, go for a person having the operation authority without hesitation, and take quick measures. Since a name and the like of an operator who logs in to the operation screen D are displayed, the operator who currently logs in can be checked on the operation screen. Therefore, the other store clerks can easily check whether the operator regularly logs in. The security can be further reinforced.

It is also possible to receive login from an operator to thereby receive the indication that the operator arrives at the store and update an attendance book stored in a server or the like in the store. This makes it possible to grasp operators (store clerks, the store manager, etc.) currently at work. Therefore, when the operation information button of the operator having the operation authority is displayed on the authentication screen E, it is possible to display an operator not at work as gray-out even if the operator has the operation authority and prevent an input of the operator from being received. Consequently, when an operator such as a store clerk not having the operation authority performs restricted operation, it is possible to immediately grasp and selectively input only an operator who has the operation authority and is at work at a point when the authentication screen is displayed. This makes it possible to more quickly perform the restricted operation.

In this embodiment, the icon for informing that the restricted input button on the operation screen E cannot be operated is displayed. However, the restricted input button only has to be displayed in a form that can be visually distinguished from the input buttons that can be operated by any operator. For example, the restricted input button may be displayed in a color different from that of the other input buttons. Since the security level falls if others notice a password, the security can be further reinforced by using other authentication techniques such as fingerprint authentication, authentication by an ID card, and vein authentication together with the authentication technique by password input.

Further effects and modifications can be easily derived by those skilled in the art. Therefore, a wider aspect of the present invention is not limited by the specific details and the representative embodiment represented and described above. Therefore, various modifications are possible without departing from the spirit or the scope of the general concept of the invention defined by the appended claims and their equivalents.

What is claimed is:

1. An information processing apparatus comprising:
an authenticating unit configured to perform, when an input from an operator not having operation authority is received on a restricted input button that can be operated only by an operator having the operation authority, authentication by the operator having the operation authority as operation restriction for the restricted input button; and
a restriction releasing unit configured to temporarily release the operation restriction for the restricted input button when the authentication by the operator having the operation authority is successful.

2. The apparatus according to claim 1, wherein the restriction releasing unit applies the operation restriction to the restricted input button again when processing for operation for which the operation restriction is temporarily released ends.

3. An information processing apparatus comprising:
a display unit configured to display a restricted input button that can be operated by only an operator having operation authority;
an authenticating unit configured to perform, when an input from an operator not having operation authority is received on the restricted input button, authentication by the operator having the operation authority as operation restriction for the restricted input button; and
a restriction releasing unit configured to temporarily release the operation restriction for the restricted input button when the authentication by the operator having the operation authority is successful.

4. The apparatus according to claim 3, wherein the authenticating unit includes:
a display control unit configured to show operator information indicating the operator having the operation authority and display, on the display unit, an authentication screen for receiving authentication by the operator having the operation authority;
an input receiving unit configured to receive, from the authentication screen, an input of operator identification information peculiar to the operator having the operation authority; and
an authentication processing unit configured to authenticate whether the operator identification information received from the authentication screen indicates the operator having the operation authority.

5. The apparatus according to claim 3, further comprising an operation display unit configured to display, when the operator not having the operation authority logs in, the restricted input button in the display unit in a form that can be visually distinguished from an input button that can be operated by any operator.

6. The apparatus according to claim 4, wherein the display control unit displays, as the operator information, an image in which the operator having the operation authority can be visually recognized.

7. The apparatus according to claim 4, wherein the input receiving unit receives, on the authentication screen, a selective input of the operator having the operation authority who is at work at a point when the display control unit displays the authentication screen.

8. An information processing method comprising:
performing, when an input from an operator not having operation authority is received on a restricted input button that can be operated only by an operator having the operation authority, authentication by the operator having the operation authority as operation restriction for the restricted input button; and
temporarily releasing the operation restriction for the restricted input button when the authentication by the operator having the operation authority is successful.

9. The method according to claim 8, wherein the releasing the operation restriction includes applying the operation restriction to the restricted input button again when processing for operation for which the operation restriction is temporarily released ends.

10. The method according to claim 8, wherein the performing authentication includes performing, when an input from the operator not having operation authority is received on the restricted input button displayed on a display unit, authentication by the operator having the operation authority.

11. The method according to claim 8, wherein the performing authentication includes:
showing operator information indicating the operator having the operation authority and displaying, on a display unit, an authentication screen for receiving authentication by the operator having the operation authority;
receiving, from the authentication screen, an input of operator identification information peculiar to the operator having the operation authority; and
authenticating whether the operator identification information received from the authentication screen indicates the operator having the operation authority.

12. The method according to claim 8, further comprising displaying, when the operator not having the operation authority logs in, the restricted input button in a display unit in a form that can be visually distinguished from an input button that can be operated by any operator.

13. The method according to claim 11, wherein the displaying an authentication screen includes displaying, as the operator information, an image in which the operator having the operation authority can be visually recognized.

14. The method according to claim 11, wherein the receiving an input of operator identification information includes receiving, on the authentication screen, a selective input of the operator having the operation authority who is at work at a point when a display control unit displays the authentication screen.
